(19) United States
(12) Patent Application Publication
(10) Pub. No.: US 2024/0141102 A1
(43) Pub. Date: May 2, 2024

(54) Process for the manufacture of polyesters

(71) Applicant: WEYLCHEM PERFORMANCE PRODUCTS GMBH, Wiesbaden (DE)

(72) Inventors: Roman Morschhäuser, Mainz (DE); Lea Festersen, Wiesbaden (DE); Niklas Diekhans, Bischhofsheim (DE); Paul Kaufmann, Hochheim (DE)

(21) Appl. No.: 18/376,157

(22) Filed: Oct. 3, 2023

(30) Foreign Application Priority Data
Oct. 18, 2022 (DE) 10 2022 003 858.7

(51) Int. Cl. C08G 63/688; C08J 3/12; C08J 11/16

(52) U.S. Cl. CPC C08G 63/6886; C08J 3/12; C08J 11/16; C08J 2367/03

(57) ABSTRACT

Disclosed is a process for the preparation of polyesters, comprising the following steps and characterized by the following measures:
a) suspending polyethylene terephthalate waste in ethylene glycol and/or in 1,2-propylene glycol containing a transesterification catalyst,
b) heating the reaction mixture to depolymerize the polyethylene terephthalate waste for a time sufficient to decompose the polyethylene terephthalate into monomers and into oligomers,
c) addition of end group forming monomers in the form of polyalkylene glycol monoalkyl ethers, fatty alcohols, fatty amines, fatty acids or esters thereof or mixtures of two or more thereof, and/or sulfo(poly)alkylene glycols and/or sulfoaryl carboxylic acids or esters thereof,
d) addition of sulfoarylene dicarboxylic acids or polyester-forming derivatives thereof,
e) optionally adding aliphatic diols, cycloaliphatic diols, organic dicarboxylic acids, their polyester-forming derivatives, crosslinkers or mixtures of two or more thereof,
f) heating the reaction mixture while distilling off ethylene glycol, optionally 1,2-propylene glycol and further compounds present in the reaction mixture or formed by transesterification and polycondensation, with the proviso that the temperature of the reaction mixture does not exceed 250° C.

This process enables the production of polyethylene or polypropylene terephthalates with selected end groups from polyester waste. The process products are characterized by good soil release properties and can be used as additives in detergents and cleaning agents.

### CLAIM FOR PRIORITY

This application is a national phase application of DE 10 2022 003 858.7, filed on Oct. 18, 2022, the priority of which is hereby claimed and its disclosure incorporated herein by reference in its entirety.

### TECHNICAL FIELD

The invention relates to the production of selected polyesters for use in detergents and cleaning agents. These polyesters are characterized by very good soil release properties.

### BACKGROUND

The use of polyesters in detergents to improve soil release from textiles, to reduce resoiling, to protect fibers under mechanical stress and to provide fabrics with an anti-crease effect is well known. These polyesters are known as SRP grades or as polyesters with soil release properties. A variety of SRP grades, their production and their use in detergents and cleaning agents are described in the patent literature.

Until now, such polyesters have been produced by conventional polycondensation processes from the monomers required to build up the polymer backbone and end groups. This mainly involved the use of dimethyl terephthalate, ethylene glycol and/or 1,2-propylene glycol derived from fossil sources.

To conserve resources, great efforts are currently being made to replace raw materials derived from fossil sources with alternative raw materials. One possibility is to use waste-derived polyethylene terephthalate, PET, as a raw material.

PET waste, so-called r-PET, from a wide variety of sources is available in large quantities. It is known that PET can be degraded to monomers or oligomers by hydrolysis or transesterification. The product obtained can then be reused as a starting material for the production of polyesters. Such processes are described, for example, in DE 42 20 473 A1, DE 698 03 212 T2 and DE 100 82 910 T1. The polymers newly produced there from the polyester waste are obtained under typical polycondensation conditions, i.e. at temperatures significantly above 250° C.

In the production of polyesters, such as PET or PBT, conventional polycondensation processes use melts at temperatures well above 200° C., e.g. at temperatures of 260° C. and above. Such high temperatures are technically challenging and require the use of significant amounts of energy and specialized equipment.

### SUMMARY OF THE INVENTION

It has now been surprisingly found that in the production of SRP grades starting from waste-derived PET, polycondensation can be carried out in standard stirred tanks and at significantly lowered temperatures.

The process products are water-soluble or water-dispersible and are characterized by improved biodegradability compared to conventional PET waste.

The objective of the present invention is to provide a process for SRP production that is energetically favorable, can be carried out with reusable raw materials and in conventional stirred tanks.

The present invention relates to a process for the production of polyesters, comprising the following steps and characterized by the following measures:
a) suspending polyethylene terephthalate waste in ethylene glycol and/or in 1,2-propylene glycol containing a transesterification catalyst,
b) heating the reaction mixture to depolymerize the polyethylene terephthalate waste for a time sufficient to decompose the polyethylene terephthalate into monomers and into oligomers,
c) addition of end group forming monomers in the form of polyalkylene glycol monoalkyl ethers, fatty alcohols, fatty amines, fatty acids or esters thereof or mixtures of two or more thereof, and/or sulfo(poly)alkylene glycols and/or sulfoaryl carboxylic acids or esters thereof,
d) addition of sulfoarylene dicarboxylic acids or polyester-forming derivatives thereof,
e) optionally adding aliphatic diols, cycloaliphatic diols, organic dicarboxylic acids, their polyester-forming derivatives, crosslinkers or mixtures of two or more thereof, preferably of further ethylene glycol and/or 1,2-propylene glycol and/or of terephthalic acid or its polyester-forming derivatives,
f) heating the reaction mixture while distilling off ethylene glycol, optionally 1,2-propylene glycol and further compounds present in the reaction mixture or formed by transesterification and polycondensation, with the proviso that the temperature of the reaction mixture does not exceed 250° C.

### DETAILED DESCRIPTION OF THE INVENTION

The polyesters prepared according to the invention contain bifunctional units, i.e. ethylene terephthalate units and ethylene sulfoarylene dicarboxylate units or 1,2-propylene terephthalate units and 1,2-propylene sulfoarylenedicarboxylate units or ethylene terephthalate units, ethylene sulfoarylene dicarboxylate units, 1,2-propylene terephthalate units and 1,2-propylene sulfoarylene dicarboxylate units in the molecule. The polyesters prepared according to the invention also contain monofunctional units, i.e. nonionic end groups bonded via terminal carboxyl groups of the polyester and derived from polyalkylene glycol monoalkyl ethers, fatty alcohols, fatty amines or mixtures of two or more thereof, and/or ionic end groups bonded via terminal carboxyl groups of the polyester and derived from sulfo(poly)alkylene glycols and/or nonionic end groups bonded via terminal hydroxyl groups of the polyester and derived from fatty acids or esters thereof and/or ionic end groups bonded via terminal hydroxyl groups of the polyester and derived from sulfoarylcarboxylic acids or esters thereof.

The proportion of all bifunctional units in the polyester produced according to the invention, based on the proportion of all mono- and bifunctional units, is preferably a minimum of 50 mol %.

The proportion of all monofunctional units in the polyester produced according to the invention, based on the proportion of all mono- and bifunctional units, is preferably a maximum of 50 mol %.

The process according to the invention can be carried out in different apparatus. For example, the entire process can be carried out in a stirred tank. However, extruders can also be used, or combinations of extruders with stirred vessels.

The polyethylene terephthalate waste used in step a) of the process according to the invention can come from a wide variety of sources. There may be used polyethylene terephthalate articles, such as used PET fibers, used PET films, or products obtained from used PET bottles, or there may be used residues from PET production or processing, such as waste from injection molding or other molding processes, or fiber preparations.

The polyethylene terephthalate waste used in step a) of the process according to the invention can have a wide variety of forms. Fibers, for example, can be used as such or, if necessary, shortened to selected lengths prior to their use. Films and PET bottles are usually shredded before use for better manageability. Residues from PET production or processing are also shredded before use, unless they are already in manageable dimensions.

The polyethylene terephthalate waste used in step a) of the process according to the invention does not necessarily have to consist of sorted PET. For example, mixed fabrics with such components can also be used which can be separated without problems before carrying out the process according to the invention or which do not interfere with the carrying out of the process according to the invention and can be separated without problems from the reaction mixture afterwards. Examples of such products are, for example, textile fabrics made of PET fibers and reinforcing fibers, such as glass or carbon fibers. Other examples of such products include textile fabrics made from blends of PET fibers and natural fibers, such as cellulose fibers or cotton fibers. Preferably, foreign type products are removed from the reaction mixture at the end of step b).

Preferably, single grade PET waste is used in step a).

In step a) of the process according to the invention, freshly produced PET can also be used in addition to polyethylene terephthalate waste. The proportion of freshly produced PET, for example in the form of flakes or pellets, is usually well below 50% by weight, preferably below 10% by weight, of the total amount of PET used in this step.

Preferably, only PET waste is used in step a).

Preferably, the polyethylene terephthalate waste used in step a) of the process according to the invention is in the form of discs or cylinders, for example as flakes or as pellets. The diameter of these discs or cylinders can vary over wide ranges. Preferably, their diameter is 10 μm to 20 cm, in particular 0.1 cm to 10 cm.

The PET used in step a) of the process according to the invention is suspended in ethylene glycol and/or in 1,2-propylene glycol. In the case that the end product is a polyester consisting mainly or entirely of repeating units with ethylene glycol units, the use of ethylene glycol as the suspending medium is recommended. In case the final product is a polyester consisting mainly or entirely of repeating units with 1,2-propylene glycol units, it is recommended to use 1,2-propylene glycol as suspending medium. In case the final product is a polyester consisting mainly or entirely of repeating units with ethylene glycol and 1,2-propylene glycol units, it is recommended to use a mixture of ethylene glycol and 1,2-propylene glycol as suspending medium.

Suspension of the PET can be aided by heating and stirring the solvent. Typical temperatures for this step range from 10 to 150° C., preferably from 20 to 100° C.

The reaction mixture generated in step a) further contains a transesterification catalyst. Several such catalysts may also be used. These catalysts are known to those skilled in the art. The transesterification catalyst can already be present in the PET waste used or it can be added to the reaction mixture in steps a) or b). Further transesterification catalyst can be added in the subsequent polycondensation step f).

Examples of suitable catalysts are titanium compounds soluble in ethylene glycol or 1,2-propylene glycol, such as tetraisopropyl titanate or tetrabutyl titanate, or tin compounds, such as n-butyltin hydroxide oxide or monobutyltin tris-(2-ethylhexanoate), and alkali metal or alkaline earth metal alcoholates or antimony trioxide/calcium acetate.

In step b) of the process according to the invention, the reaction mixture obtained in step a) is heated to achieve depolymerization of the PET. Temperature, pressure and duration in this step are to be selected so that at the end of this step the polyethylene terephthalate waste has decomposed into monomers and short-chain oligomers.

The depolymerization of the PET in step b) is carried out using ethylene glycol and/or 1,2-propylene glycol in suspension or in solution in the presence of transesterification catalysts. Typically, the process is carried out in the boiling heat of the glycols used. The aim of this depolymerization step is to reduce the chain lengths of the PET down to the monomers, diglycol terephthalate or oligomers thereof. The chain length of the oligomers produced at the end of step b) should not exceed 10 ethylene terephthalate repeating units. At the end of depolymerization, all the PET used must have dissolved clearly in the glycol used. Otherwise, excessively long PET domains are formed, which are detrimental to the mode of action of the subsequent process product.

The temperatures of the reaction mixture in step b) are usually between 150 and 200° C. Preferably, work is carried out in the range of the boiling temperature of the glycol or glycol mixture used, i.e. in the range between 185 and 200° C.

The other depolymerization parameters, i.e. pressure, introduced mechanical energy and reaction time, are related to the apparatus used, such as stirred tank or extruder. Stirred vessels are particularly suitable for discontinuous operation and for smaller plants.

In general, the pressure in stage b) is between 0 and 5 bar, preferably between 1 and 2.5 bar, and most preferably 1 bar or normal pressure (physical atmosphere of 1.013 bar).

Generally, the reaction mixture is stirred in step b). Typical stirring speeds range from 10 to 40 rpm at the beginning of the depolymerization and 100 to 150 rpm at the end of the depolymerization. Typical reaction times in step b) range from 1 h to 50 h, preferably 90 to 600 min.

Optionally, monomers which are to be incorporated into the later process product as part of the polyester chain can already be added to the reaction mixture while the depolymerization is being carried out in step b). Examples of such monomers are dimethyl terephthalate, dimethyl sulfoisophthalate or its alkali metal salt. Preferably, however, such monomers are not added to the reaction mixture until step d) or e).

When carrying out step b), it is useful to remove low-molecular-weight constituents formed during the transesterification, such as water or methanol, or constituents of the solvent, such as ethylene glycol or 1,2-propylene glycol, from the reaction mixture. In this process, ethylene glycol and/or 1,2-propylene glycol or other diols that are to be incorporated into the later process product as part of the polyester chain can be added to the reaction mixture at the same time. Preferably, however, such glycols or diols are not added to the reaction mixture until step e).

After completion of step b), those monomers and reactants which are to form the polyester chain of the final product and its end groups are added to the reaction mixture containing predominantly ethylene glycol and/or 1,2-propylene glycol and ethylene terephthalate oligomers.

For this purpose, the reaction mixture can be removed from the previous reactor and transferred to a new reactor. Advantageously, the reaction mixture is left in the previous reactor and the reaction is carried out as a one-pot reaction.

When these monomers and reactants are added, the pressure and temperature at the end of step b) can be maintained or changed. For example, the reaction mixture can be depressurized if excess pressure is present at the end of step b) and the monomers can be added to the reaction mixture in steps c), d) and optionally e) at the temperature of the reaction mixture at the end of step b). Alternatively, the reaction mixture can be cooled before starting the addition of the monomers and reactants.

In step c), end-group forming reactants are added to the reaction mixture. These are polyalkylene glycol monoalkyl ethers, fatty alcohols, fatty amines, fatty acids or esters thereof or mixtures of two or more thereof, which form non-ionic end groups in the process product. Instead, sulfo-(poly)-alkylene glycols, sulfoaryl carboxylic acids or esters thereof which form ionic end groups in the process product may be added. However, mixtures of non-ionic end groups and ionic end group-forming reactants can also be added.

Preferably, the polyalkylene glycol monoalkyl ethers are compounds of formula (I), the fatty alcohols are compounds of formula (II), the fatty amines are compounds of formula (III), the fatty acid (esters) are compounds of formula (IV), the sulfo(poly)alkylene glycols are compounds of formula (V), and the sulfoaryl carboxylic acids and esters thereof are compounds of formula (VI)

H—(O—CₘH₂ₘ)ₙ—OR¹ (I),

R²—OH (II),

R²—NH₂ (III),

R²—COOR³ (IV),

H—(O—CₒH₂ₒ)ₚ—SO₃⁻(Mⁱ⁺)_{1/l} (V),

R³OOC—C₆H₄—SO₃⁻(Mⁱ⁺)_{1/l} (VI),
wherein
R¹ is C₁-C₆ alkyl, cycloalkyl, aryl or aralkyl,
R² is straight-chain or branched alkyl having 6-20 carbon atoms,
R³ is hydrogen, C₁-C₆ alkyl, cycloalkyl, aryl or aralkyl
m and o are independently of one another 2 or 3,
n is an integer from 5 to 250
p is an integer from 1 to 10,
M is a cation of valency i, and
i is an integer from 1 to 4.

These compounds are known and are already used to form end groups in SRP.

In step d), sulfoarylene dicarboxylic acids or their polyester-forming derivatives are added to the reaction mixture. These are aromatic dicarboxylic acids containing one or more sulfo groups, their esters or acid halides. Examples are terephthalic acids, isophthalic acids, phthalic acids or naphthalenedicarboxylic acids containing one or two sulfo groups, or their mono- or dialkyl esters, preferably their mono- or dimethyl esters, or their acid chlorides. Instead of the sulfo-containing aromatic dicarboxylic acids, esters or acid halides, salts of sulfo-containing aromatic dicarboxylic acids, esters or acid halides can also be used. Examples are alkali salts, such as sodium or potassium salts, or ammonium salts.

Preferably, a sulfoisophthalic acid or a salt of this acid is used as sulfoarylene dicarboxylic acid, or a mono- or diester of sulfoisophthalic acid or a salt thereof is used as a polyester-forming derivative thereof.

Particularly preferred is a 5-sulfoisophthalic acid, an alkali salt of 5-sulfoisophthalic acid, a mono- or dialkyl ester of 5-sulfoisophthalic acid or a mono- or dialkyl ester of an alkali salt of 5-sulfoisophthalic acid.

In step e), aliphatic diols, cycloaliphatic diols, organic dicarboxylic acids, polyester-forming derivatives thereof, crosslinkers or mixtures of two or more thereof may optionally be added to the reaction mixture.

The aliphatic diols may be ethylene glycol and/or 1,2-propylene glycol, which to a large extent form the diol component in the polyester chain of the process product. However, it can also be aliphatic or cycloaliphatic diols, which form a small proportion of the diol component in the polyester chain of the process product. Examples of such diols are polyethylene glycols, polypropylene glycols, polybutylene glycols, 1,2-butylene glycol, 1,4-dimethylolcyclohexane or 1,4-diethylolcyclohexane.

The organic dicarboxylic acids or their polyester-forming derivatives may be terephthalic acid or dimethyl terephthalate, which form a large proportion of the dicarboxylic acid component in the polyester chain of the process product. However, they may also be aliphatic, cycloaliphatic or aromatic dicarboxylic acids or their polyester-forming derivatives, which form a small proportion of the dicarboxylic acid component in the polyester chain of the process product. Examples of such dicarboxylic acids are adipic acid, sebacic acid, cyclohexanedicarboxylic acid, isophthalic acid or naphthalenedicarboxylic acids or the corresponding mono- or dimethyl esters of these dicarboxylic acids.

The crosslinkers are tri- or higher-functional compounds with which the chain of the polyester end product can be branched or with which several polyester chains can be linked together. Examples of crosslinkers are tri- or tetrafunctional alcohols or carboxylic acids, such as trimethylolpropane, pentaetythritol, trimellitic acid, trimesic acid or pyromellitic acid or their methyl esters. Crosslinkers are added to the reaction mixture only in very small amounts, if at all, to prevent excessive crosslinking or branching. Particularly preferably, no crosslinkers are used at all.

The sequence of steps c), d) and optionally e) can be changed as desired. It is also possible to add all monomers and reactants from steps c), d) and optionally e) to the reaction mixture in a common step.

After the addition of the monomers and reactants in steps c), d) and optionally e) of the process according to the invention, the polycondensation to the desired end product takes place in step f) of the process according to the invention.

The synthesis of the polyester in step f) is carried out according to a procedure known per se in that the monomers required for the formation of the desired polyester are first pre-esterified at normal pressure to temperatures of up to 220° C., preferably using an inert atmosphere, with the addition of a catalyst. In addition to the catalyst, a salt of a short-chain carboxylic acid, preferably acetate, is preferably added to the reaction mixture.

After pre-esterification, the desired molecular weights can be built up in vacuo at temperatures from 160 to 250° C. by distilling off superstoichiometric amounts of the glycols used.

The molecular weight of the desired polyester can be controlled by selecting the proportions of alcohol and acid components. These procedures are known to those skilled in the art of polycondensation.

Polycondensation takes place at high temperatures of up to 250° C. and with separation of volatile compounds. Since polycondensation is an equilibrium reaction, the separation of volatile reaction products from the reaction mixture promotes the formation of polyesters.

During the polycondensation, the volatile reaction products formed during the polycondensation should always be distilled off in the reaction mixture. Optionally, further ethylene glycol or 1,2-propylene glycol can be added during the polycondensation, in particular continuously distributed over the entire reaction period.

In step f), additional catalyst corresponding to, for example, 50 to 250 ppm titanium or tin can be fed in.

The reaction time in step f) must ensure a practically quantitative conversion of the ethylene terephthalate oligomers and monomers from step b) and the other monomers and reactants from steps c), d) and optionally e) to the desired polyester.

The temperatures of the reaction mixture in step f) are usually between 150 and 250° C., in particular between 160 and 235° C. Preferably, the reaction is carried out in the range of the melt temperature of the polyester mixture formed, very preferably in the range between 185 and 235° C.

As in step b), the other polycondensation parameters, i.e. pressure, introduced mechanical energy and reaction time, are related to the apparatus used, such as stirred tank or extruder.

When carrying out step f), normal pressure or, in particular, negative pressure is usually used.

The pressure in step f) is preferably from 0.1 mbar to 1.013 bar (normal pressure). In particular, work is carried out at pressures of 5 to 500 mbar. Typically, polycondensation is started at normal pressure and towards the end of the polycondensation is carried out at negative pressure.

When carrying out step f), the reaction mixture is preferably stirred. Typical stirring speeds range from 10 to 200 rpm. Typical reaction times in step f) range from 30 min to 20 h, preferably from 45 min to 12 h.

After completion of the polycondensation in step f), the hot reaction mixture is in liquid form. Subsequently, the reaction mixture is allowed to cool in a step g), resulting in the desired end product as a solid.

This is then separated from the liquid components of the reaction mixture in step h), for example by filtration.

Alternatively, the process product obtained after completion of the polycondensation in step f) can be transferred from the reactor to a granulation device and processed into granules.

The solid process product obtained can also be dissolved in water or in an aqueous-alcoholic mixture. The proportion by weight of polyester in the aqueous or aqueous-alcoholic solution can be from 5.0 to 80.0% by weight, preferably from 10.0 to 75.0% by weight and particularly preferably from 50.0 to 70.0% by weight, in each case based on the total weight of the aqueous solution.

The process products are preferably polyesters comprising
A) structural units of formula (VII) or of formula (VIII) or of formulae (VII) and (VIII),
B) structural units of formula (IX) or of formula (X) or of formulae (IX) and (X), and
C) optionally structural units of the formula (XI)

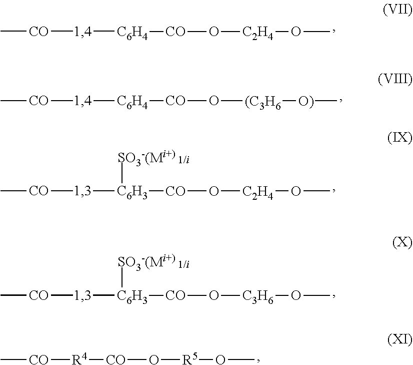

wherein the proportion of structural units A), B) and optionally C) is 100% of all structural units in the polyester, and
wherein the polyester contains end groups of formula (XII), (XIII), (XIV), (XV), (XVI) or (XVII), or of formulae (XII) and (XVI), or (XII) and (XVII), or (XII), (XVI) and (XVII), or of formulae (XIII) and (XVI), or (XIII) and (XVII) or (XIII), (XVI) and (XVII), or the formulae (XIV) and (XVI), or (XIV) and (XVII), or (XIV), (XVI) and (XVII), or the formulae (XV) and (XVI), or (XV) and (XVII), or (XV), (XVI) and (XVII)

—(O—CₘH₂ₘ)ₙ—OR¹ (XII),

R²—O— (XIII),

R²—NH— (XIV),

R²—COO— (XV),

—(O—CₒH₂ₒ)ₚ—SO₃⁻(Mⁱ⁺)_{1/l} (XVI),

—OC—C₆H₄—SO₃⁻(Mⁱ⁺)_{1/l} (XVII),
wherein end groups of the formulae (XII), (XIII), (XIV) and (XVI) are bonded to terminal carboxyl groups of the polyester and end groups of the formulae (XV) and (XVII) are bonded to terminal hydroxyl groups of the polyester, and wherein in addition to the end groups of the formulae (XII), (XIII), (XIV), (XV); (XVI) and (XVII) and optionally terminal carboxyl and hydroxyl groups, no further end groups are present in the polyester, and wherein
-1,4-C₆H₄— represents 1,4-phenylene,

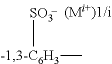

represents sulfo-1,3-phenylene,
R¹ is C₁-C₆-alkyl, cycloalkyl, aryl or aralkyl,
R² is straight-chain or branched alkyl with 6-20 carbon atoms,
R³ is hydrogen, C₁-C₆-alkyl, cycloalkyl, aryl or aralkyl
R⁴ is an alkylene, cycloalkylene or arylene radical with the exception of 1,4-phenylene or sulfo-1,3-phenylene
R⁵ is an alkylene radical, a radical derived from polyoxyalkylene or a cycloalkylene radical.
m and o are independently of one another 2 or 3,
n is an integer from 5 to 250, preferably from 15 to 120,
p is an integer from 1 to 10, preferably from 1 to 5, and in particular 1 or 2,
M is a cation of valency i, and
i is an integer from 1 to 4.

The weight-average molecular weights Mw of the polyesters produced according to the invention are generally in the range from 2,500 g/mol to 20,000 g/mol, preferably 3,000 g/mol to 15,000 g/mol, and particularly preferably 4,000 g/mol to 13,000 g/mol.

The generation of the desired molecular weights can be achieved by selecting the ratios of the individual monomers to one another. This procedure is known to the person skilled in the art.

The weight average of the molecular weights is determined by size exclusion chromatography. This is preferably carried out in a mixture of water and acetonitrile, with calibration using sulfonated polystyrene standards with narrow molecular weight distribution. Narrow molecular weight distribution here means a polydispersity Ð (M_{w}/Mₙ) of less than 1.5.

Preferably, n is an integer from 15 to 120, and p is an integer from 1 to 5, and in particular 1 or 2.

Preferably, i is an integer from 1 to 2, and in particular 1.

M is preferably a cation of an alkali metal, of hydrogen or an ammonium cation, in particular a cation of sodium or potassium.

R¹ is preferably C₁-C₆alkyl, in particular methyl or ethyl.

R² is preferably straight-chain or branched alkyl with 8 to 16 carbon atoms.

R³ is preferably hydrogen or C₁-C₆ alkyl, in particular hydrogen, methyl or ethyl.

R⁴ is preferably an alkylene radical having 2 to 8 carbon atoms or a cyclohexylene radical, in particular a radical derived from adipic acid, sebacic acid or 1,4-cyclohexanedicarboxylic acid.

R⁵ is preferably an alkylene radical having 2 to 4 carbon atoms, a radical derived from polyoxyethylene, a radical derived from polyoxypropylene or a radical derived from 1,4-cyclohexanedimethylol or from 1,4-cyclohexanediethylol, in particular a radical derived from ethylene glycol, 1,2-propylene glycol, 1,2-butylene glycol, polyoxyethylene having 2 to 50 oxyethylene repeating units or a radical derived from polyoxypropylene having 2 to 50 oxypropylene repeating units.

Preferred polyesters prepared according to the invention contain, in addition to the structural units of the formulae (VII) and (IX) or of the formulae (VIII) and (X) or of the formulae (VII), (VIII), (IX) and (X) and terminal hydroxyl and/or carboxyl groups which may be present, only end groups of the formula (XII) or (XVI) or of the formulae (XII) and (XVII).

The proportion of structural units of the formula (VII) or of the formula (VIII) or of the formulae (VII) and (VIII) in the polyester prepared according to the invention is usually from 5 to 95 mol %, based on all structural units.

The proportion of structural units of the formula (IX) or of the formula (X) or of the formulae (IX) and (X) in the polyester prepared according to the invention is usually 5 to 95 mol %, based on all structural units.

The proportion of structural units of the formula (XI) in the polyester prepared according to the invention is usually 0 to 5 mol %, based on all structural units. Preferably, the polyester prepared according to the invention does not contain any structural units of the formula (XI).

The proportion of end groups of formula (XII), (XIII), (XIV), (XV), (XVI) or (XVII), or of formulae (XII) and (XVI), or (XII) and (XVII), or (XII), (XVI) and (XVII), or of formulae (XIII) and (XVI), or (XIII) and (XVII), or (XIII), (XVI) and (XVII), or of the formulae (XIV) and (XVI) or (XIV) and (XVII), or (XIV), (XVI) and (XVII), or of the formulae (XV) and (XVI) or (XV) and (XVII), or (XV), (XVI) and (XVII) in the polyester prepared according to the invention is typically 95 to 100 mol %, based on all end groups in the polyester. Other possible end groups include terminal hydroxyl or carboxyl groups.

Preferred polyesters prepared according to the invention have, in addition to terminal hydroxyl and/or carboxyl groups which may be present, only end groups of the formula (XII) or (XVI) or of the formulae (XII) and (XVI). where the proportion of end groups of the formula (XII) is from 5 to 95 mol % and the proportion of end groups of the formula (XVI) is from 95 to 5 mol %, based on all end groups in the polyester.

The polyesters prepared according to the invention can be incorporated in detergents and cleaning agents in various dosage forms.

Detergents and cleaning agents can be in the form of granules, tablets, gels, aqueous dispersions or aqueous solutions.

The polyesters produced according to the invention impart significantly improved soil release properties to textile fibers and substantially support the soil release capacity of the other components of detergents and cleaning agents against oily, greasy or pigment soilings.

A further advantage can be the use of the polyesters produced according to the invention in after-treatment agents for laundry, for example in a fabric softener.

With the aid of the polyesters produced according to the invention in cleaning agents for surfaces, in particular for hard surfaces, the treated surfaces can be given a soil-repellent finish.

The polyesters produced according to the invention can also be incorporated in household cleaning agents, for example in all-purpose cleaners, or in dishwashing detergents, in carpet cleaning and impregnating agents, in cleaning and care agents for floors and other hard surfaces, e.g. made of plastic, ceramics, glass or surfaces coated with nanotechnology.

Examples of technical cleaning agents are plastic cleaning and care agents, for example for housings and car fittings, and cleaning and care agents for painted surfaces such as car bodies.

### EXAMPLES

The following examples are intended to explain the invention without limiting it thereto.

### Example 1a (Prepraration of a Precursor, Depolymerization Stage)

In a 3 liter three-neck flask with reflux condenser, KPG stirrer and internal thermometer, 200 grams of purified r-PET granules were introduced. This corresponds to a molar weight of 1.44 mol terephthalic acid (assumed density of 1.38 g/cm³ and a molecular weight of the repeating unit of 192.17 g) and 500 ml 1,2-ethylene glycol were added. After inerting with nitrogen, 0.2 g Ti(iprop)₄ and 0.3 g sodium acetate were added as transesterification catalyst and the reaction mixture was heated to boiling temperature (190° C.). The mixture was boiled at reflux until all solids had dissolved.

The reaction time up to this point depends here on the size of the granules used. After complete dissolution of the r-PET (6 hours), heating was continued at reflux for an additional 4 hours to complete the reaction. Subsequently, it was cooled down to room temperature. The content of diglycol terephthalate was determined by calculation from the initial weight.

### Example 1b (Main Condensation)

Subsequently, 106.56 g of sulfoisophthalic acid dimethyl ester Na salt (0.36 mol) and 1440 g of MPEG 2000 (methoxypolyethylene glycol medium molecular weight 2000) and 50 g of additional ethylene glycol were added to the precursor in the same flask and then heated to 200° C. using an oil bath under nitrogen inertization. Small amounts of methanol were removed by distillation. At the end of the methanol run, best vacuum was applied within half an hour (2 mbar) while slowly heating the reaction mixture. This was done to an extent that the effluent of the excess glycol proceeded in a controlled manner. When 230° C. was reached in the best vacuum, condensation continued for another 2 hours under the same conditions. And then cooled, aerated and the product was discharged as a melt at 120° C. onto steel sheets.

### Example 2a (Preparation of a Precursor, Depolymerization Stage)

In a 3 liter three-neck flask with reflux condenser, KPG stirrer and internal thermometer, 200 grams of purified r-PET granules were introduced. This corresponds to a molar weight of 1.44 mol terephthalic acid (assumed density of 1.38 g/cm³ and a molecular weight of the repeating unit of 192.17 g) and 250 ml 1,2-propylene glycol and 250 ml ethylene glycol were added. After inerting with nitrogen, 0.25 g of Ti(iprop)₄ and 0.35 g of sodium acetate were added as a transesterification catalyst and the reaction mixture was heated to boiling temperature (about 190° C.). The mixture was boiled at reflux until all solids had dissolved.

The reaction time up to this point depends here on the size of the granules used. After complete dissolution of the r-PET (6 hours), heating at reflux was continued for another 4 hours to complete the reaction. Subsequently, it was cooled to room temperature. The content of diglycol terephthalate was determined by calculation from the weighed sample.

### Example 2b (Main Condensation)

Subsequently, 90.00 g of sulfoisophthalic acid dimethyl ester Na salt (0.30 mol) and 720 g of MPEG 1000 (methoxypolyethylene glycol medium molecular weight 1000) and 0.1 g of Ti(iprop)₄ were additionally added to the precursor in the same flask and then heated to 200° C. using an oil bath under nitrogen inertization. Small amounts of methanol were removed by distillation. At the end of the methanol run, best vacuum was applied within half an hour (2 mbar) while slowly heating the reaction mixture. This was done to an extent that the effluent of the excess glycol proceeded in a controlled manner. When 230° C. was reached in the best vacuum, condensation was continued for another 2 hours under the same conditions, followed by cooling, aeration and discharge of the product as a melt at 120° C. onto steel sheets.

### Example 3a (Preparation of a Precursor, Depolymerization Stage)

In a 3 liter three-neck flask with reflux condenser, KPG stirrer and internal thermometer, 200 grams of purified r-PET granules were introduced. This corresponds to a molar weight of 1.44 mol terephthalic acid (assumed density of 1.38 g/cm³ and a molecular weight of the repeating unit of 192.17 g) and 500 ml 1,2-propylene glycol was added. After inerting with nitrogen, 0.25 g of Ti(iprop)₄ and 0.35 g of sodium acetate were added as transesterification catalyst and the reaction mixture was heated to boiling temperature (about 190° C.). The mixture was boiled at reflux until all solid components had dissolved.

The reaction time up to this point depends on the size of the granules used. After complete dissolution of the r-PET (9 hours), heating at reflux was continued for another 4 hours to complete the reaction. Subsequently, it was cooled to room temperature. The content of diglycol terephthalate was determined by calculation from the initial weight.

### Example 3b (Main Condensation)

Subsequently, 90.00 g of sulfoisophthalic acid dimethyl ester Na salt (0.30 mol), 50 g of cyclohexanedimethanol and 720 g of MPEG 1000 (methoxypolyethylene glycol medium molecular weight 1000) were added to the precursor in the same flask and then heated to 200° C. using an oil bath under nitrogen inertization. Small amounts of methanol were removed by distillation. At the end of the methanol runoff, best vacuum was applied within half an hour (2 mbar) while slowly heating the reaction mixture. Throughout the condensation, a total of 500 ml of 1,2-propylene glycol was continuously dropped in via a suitable vacuum-capable dropping funnel. This is done to an extent that the effluent of the excess glycol proceeded in a controlled manner. When 230° C. was reached in the best vacuum, further condensation was carried out for another 2 hours under the same conditions and then the product was cooled, aerated and discharged as a melt at 120° C. onto steel sheets.

1. A process for the preparation of polyesters, comprising the following steps:
a) suspending polyethylene terephthalate waste in at least one of ethylene glycol and 1,2-propylene glycol containing a transesterification catalyst,
b) heating the reaction mixture to depolymerize the polyethylene terephthalate waste for a time sufficient to decompose the polyethylene terephthalate into monomers and into oligomers,
c) adding at least one of end group forming monomers comprising polyalkylene glycol monoalkyl ethers, fatty alcohols, fatty amines, fatty acids or esters thereof, mixtures of two or more thereof, sulfo(poly)alkylene glycols, and sulfoaryl carboxylic acids or esters thereof,
d) adding sulfoarylene dicarboxylic acids or polyester-forming derivatives,
e) optionally adding at least one of aliphatic diols, cycloaliphatic diols, organic dicarboxylic acids, their polyester-forming derivatives, and crosslinkers or mixtures of two or more thereof, and,
f) heating the reaction mixture while distilling off ethylene glycol, transesterification and polycondensation reactants present in the reaction mixture, or ethylene glycol, 1,2-propylene glycol, transesterification and polycondensation reactants present in the reaction mixture with the proviso that the temperature of the reaction mixture does not exceed 250° C.

2. The Process of claim 1, wherein the polyester contains:
a) bifunctional units selected from the group of ethylene terephthalate units, ethylene sulfo arylene dicarboxylate units, 1,2-propylene terephthalate units, 1,2-propylene sulfo arylene dicarboxylate units or ethylene terephthalate units, ethylene sulfo arylene dicarboxylate units, 1,2-propylene terephthalate units, and 1,2-propylene sulfoarylenedicarboxylate units, and
b) monofunctional units selected from the group of
i) nonionic end groups bonded via terminal carboxyl groups of the polyester and derived from polyalkylene glycol monoalkyl ethers, fatty alcohols, fatty amines, mixtures of two or more thereof,
ii) ionic end groups bonded via terminal carboxyl groups of the polyester derived from sulfo(poly)alkylene glycols and
iii) nonionic end groups bonded via terminal hydroxyl groups of the polyester derived from fatty acids, esters thereof,
iv) ionic end groups bonded via terminal hydroxyl groups of the polyester derived from sulfoarylcarboxylic acids or esters thereof,
the proportion of all bifunctional units, based on the proportion of all mono- and bifunctional units, being at least 50 mol.-% and the proportion of all monofunctional units, based on the proportion of all mono- and bifunctional units, being at most 50 mol %.

3. The Process according to claim 1, wherein the polyalkylene glycol monoalkyl ethers are compounds of formula (I), the fatty alcohols are compounds of formula (II), the fatty amines are compounds of formula (III), the fatty acid (esters) are compounds of formula (IV), the sulfo(poly)alkylene glycols are compounds of formula (V) and the sulfoarylcarboxylic acids or their esters are compounds of formula (VI)
H—(O—CₘH₂ₘ)ₙ—OR¹ (I),
R²—OH (II),
R²—NH₂ (III),
R²—COOR³ (IV),
H—(O—CₒH₂ₒ)ₚ—SO₃⁻(Mⁱ⁺)_{1/l} (V),
R³OOC—C₆H₄—SO₃⁻(Mⁱ⁺)_{1/l} (VI),
wherein
R¹ is C₁-C₆ alkyl, cycloalkyl, aryl or aralkyl,
R² is straight-chain or branched alkyl having 6-20 carbon atoms,
R³ is hydrogen, C₁-C₆ alkyl, cycloalkyl, aryl or aralkyl
m and o are independently of one another 2 or 3,
n is an integer from 5 to 250,
p is an integer from 1 to 10,
M is a cation of valency i, and
i is an integer from 1 to 4.

4. The Process according to claim 1, wherein the sulfoarylene dicarboxylic acid is at least one of a sulfoisophthalic acid or a salt of this acid and the polyester-forming derivatives thereof are at least one of mono-esters of sulfoisophthalic acid or of diesters of sulfoisophthalic acid or of a salt of these monoesters or these diesters of sulfoisophthalic acid.

5. The Process according to claim 1, wherein the polyethylene terephthalate waste used in step a) is at least one of polyethylene terephthalate fibers, polyethylene terephthalate films, products obtained from polyethylene terephthalate bottles and waste from the production and processing of polyethylene terephthalate.

6. The Process according to claim 5, wherein the polyethylene terephthalate waste is in the form of discs or cylinders comprising a diameter of from 10 μto 20 cm.

7. The Process according to claim 1, wherein in step b) the reaction mixture is heated to temperatures of 150 to 200° C. for a time sufficient to dissolve all solid constituents.

8. (canceled)

9. The Process according to claim 1, wherein in step e) alkanediols other than ethylene glycol or 1,2-propylene glycol or cycloalkanediols or mixtures of two or more of these compounds are added as further constituents.

10. The Process according to claim 1, wherein in step f) the reaction mixture is heated to temperatures of 150 to 250° C., while applying vacuum and distillation to distill off volatile compounds.

11. The Process according to claim 10, wherein pressure in step f) is applied in a range of 5 to 500 mbar.

12. The Process according to claim 1, wherein after completion of step f) the resultant hot reaction mixture is allowed to cool in a step g), to obtain the desired end product as a solid.

13. The Process according to claim 12, wherein the solid end product is separated from the liquid constituents of the reaction mixture in a step h).

14. The Process according to claim 1, wherein the product obtained after completion of the polycondensation in step f) is transferred from the reactor into a granulating device and is processed into granules.

15. The Process according to claim 13, wherein the solid product is dissolved in water.

16. The Process according to claim 4, wherein the sulfoarylene dicarboxylic acid is at least one of a 5-sulfoisophthalic acid, an alkali salt of 5-sulfoisophthalic acid, a mono- or dialkyl ester of 5-sulfoisophthalic acid, a mono- or dialkyl ester of an alkali salt of 5-sulfoisophthalic acid.

17. The Process according to claim 6, wherein the polyethylene terephthalate waste is in the form of discs or cylinders comprising a diameter of from from 0.1 cm to 10 cm.

18. The Process according to claim 1, wherein in step c) adipic acid, sebacic acid, cyclohexane dicarboxylic acid, phthalic acid, isophthalic acid or the mono- or dialkyl esters of these dicarboxylic acids are added as further constituents.

19. The Process according to claim 1 wherein in step d) adipic acid, sebacic acid, cyclohexane dicarboxylic acid, phthalic acid, isophthalic acid or the mono- or dialkyl esters of these dicarboxylic acids are added as further constituents.

20. The Process according to claim 9 wherein alkanediols selected from the group of 1,2-butylene glycol, polyethylene glycol, polypropylene glycol and dimethylolyclohexane are added as further constitutents in step e).

21. The Process according to claim 13, wherein the solid process product is dissolved in an aqueous-alcoholic mixture.
